(19) United States
(12) Patent Application Publication
(10) Pub. No.: US 2005/0248776 A1
(43) Pub. Date: Nov. 10, 2005

(54) Image transmission device and image reception device

(76) Inventor: Minoru Ogino, Tokyo (JP)

Correspondence Address: INTELLECTUAL PROPERTY / TECHNOLOGY LAW, PO BOX 14329, RESEARCH TRIANGLE PARK, NC, 27709, US

(21) Appl. No.: 10/992,163

(22) Filed: Nov. 18, 2004

(30) Foreign Application Priority Data
May 7, 2004 (JP) 2004-138457

(51) Int. Cl. G06K 15/00; H04N 1/393; H04N 1/387; H04N 1/41; H04N 5/225; H04N 1/32

(52) U.S. Cl. 358/1.2; 455/556.1; 348/207.1; 358/426.11; 348/240.99; 358/453; 358/451; 358/1.15

(57) ABSTRACT

An image transmission device and image reception device capable of quickly displaying zoomed images, even in a system using low-bitrate wireless transmission devices. The image transmission device includes a camera section that captures images, a transmission/reception section that transmits an image captured by the camera section to an image reception device, and an image processing section that performs image processing by changing the image compression ratio such that the time for transmission of images to the image reception device is substantially constant. By changing the image compression ratio such that the image transmission time is substantially constant, zoomed images can be displayed quickly on the image reception device, even in a system using low-bitrate wireless transmission devices.

### BACKGROUND

This invention relates to an image transmission device and image reception device, and in particular to an improved technology to quickly display on an image reception device a zoomed image which has been specified for zooming.

As has been disclosed in Japanese patent laid-open No. 2000-295601, remote monitoring systems are known in which a subject for monitoring is captured with a camera, the analog image signal thus obtained is converted into a digital image signal in an image transmission section and transmitted, the digital image signal received by an image reception section is converted into an analog image signal and displayed on a monitor, and camera zoom operations and other remote operations are performed by means of control signals from an operator console.

However, when on the image transmission side a camera is used for zooming which is fixed in place, embedded, or otherwise immovable, a motor or similar means drives an optical system lens to perform zooming; but in this method, complex control is necessary in order to process the incident optical image. On the other hand, if digital zooming is used, because in general the center portion of the captured image is simply enlarged and displayed, the image desired by the user cannot be easily obtained in cases where the object to be captured is not in the center or the subject size is not constant. Further, in a low-speed wireless communication environment the speed of transmission of a zoomed image is low, and it is not possible to rapidly display the image.

### SUMMARY

The present invention provides an image transmission device and image reception device that resolve the above-described problems, and can rapidly display a zoomed image even in a system employing low-bitrate wireless transmission equipment.

The invention in one aspect relates to an image transmission device, including: a camera section to capture images; a transmission/reception section to transmit captured images captured by the camera section to an image reception device; and an image processing section to perform image processing in which the image compression ratio is changed such that the time of image transmission to the image reception device is substantially constant. By changing the image compression ratio such that the image transmission time is substantially constant, zoomed images can be quickly displayed on the image reception device even in a system employing low-bitrate wireless transmission equipment.

In such device, the image processing section may be configured such that a selected range within the captured image which is specified as the zoom range is subjected to image compression. The image processing section adjusts the image compression ratio according to the size of the selected range specified as the zoom range, to render the image transmission time substantially constant.

As the method of specification of the selected range, for example, when a corner of a captured image, which has been partitioned equally into a plurality of small images arranged in the vertical and horizontal directions, is established as a reference point, it is desirable that the selected range be specified by a position relative to the reference point and by the number of small images in the horizontal and vertical directions, indicating the size of the selected range. By this means, the zoom range can easily be specified.

It is desirable that the transmission/reception section of the image transmission device perform image transmission with the image reception device by means of wireless transmission. The convenience of image transmission and reception thereby can be enhanced.

The invention in another aspect relates to an image reception device, including: a transmission/reception section to receive captured images transmitted from an image transmission device; an image processing section to perform image processing of a captured image received by the transmission/reception section; an image display section to display a captured image which has been subjected to image processing by the image processing section; and an input section to input a zoom instruction specifying a selected range for a captured image. When a zoom instruction is input to the input section, the transmission/reception section transmits the zoom instruction to the image transmission device, and the image processing section performs the zoom processing specified by the zoom instruction on the captured image being displayed on the image display section. By this means, a zoomed image can be quickly displayed on the image display section.

The invention relates in yet another aspect to an image transmission/reception system, including: an image transmission device and an image reception device as described above, wherein the image transmission device is a cordless telephone handset, and the image reception device is a cordless telephone base unit. A cordless telephone provided with image transmission/reception functions is well-suited for fixed-point observations and the like.

Other aspects, features and advantages of the invention will be more fully apparent from the ensuing disclosure and appended claims.

### DESCRIPTION OF DRAWINGS

FIG. 1 shows the overall configuration of an image transmission/reception system;

FIG. 2 shows the configuration of an image transmission device and an image reception device;

FIG. 3 depicts the flow of processing for image display;

FIG. 4 depicts the flow of processing for zoomed image display;

FIG. 5 illustrates zoom specification;

FIG. 6 illustrates layers;

FIG. 7 illustrates zoom ranges;

FIG. 8 illustrates correction of zoom ranges;

FIG. 9 illustrates correction of zoom ranges;

FIG. 10 illustrates zoom specification;

FIG. 11 is a correspondence table between image data amounts and image compression ratios;

FIG. 12 illustrates zoom ranges;

FIG. 13 illustrates zoom specification; and,

FIG. 14 illustrates correction of zoom ranges.

### DETAILED DESCRIPTION

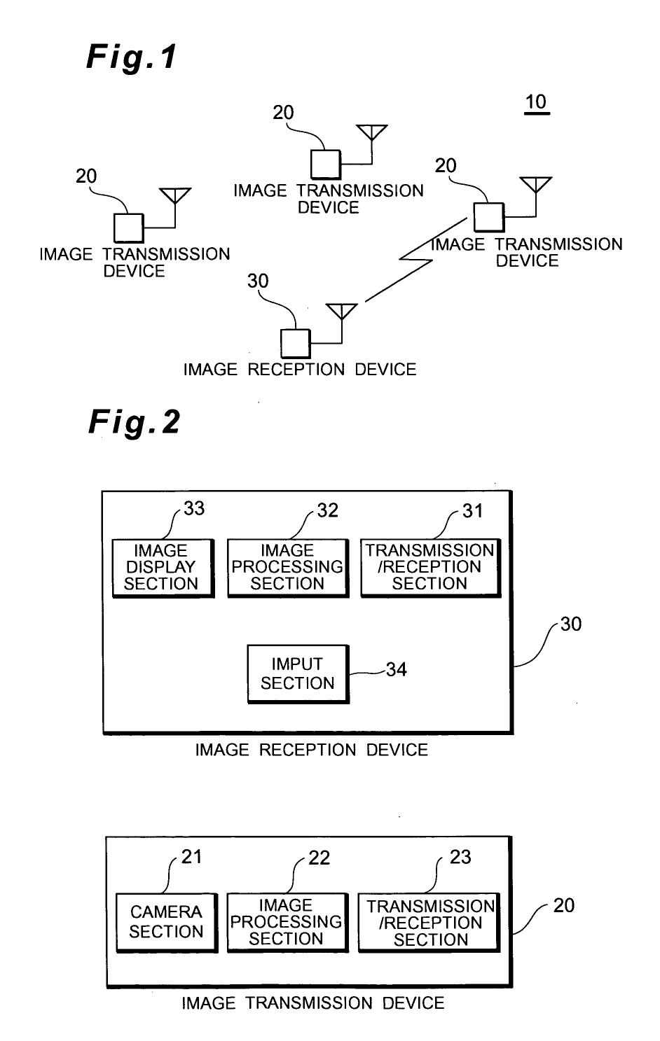

FIG. 1 shows the overall configuration of an image transmission/reception system. This system 10 is configured to include a plurality of image transmission devices provided with cameras (handsets or wireless terminals with cameras) 20, and an image reception device (base unit or wireless terminal with display device) 30, which receives captured images transmitted wirelessly from the plurality of image transmission devices 20 and displays the images. When an image transmission device 20 receives a zoom instruction by remote operation from the image reception device 30, cropping and image compression of the captured image are performed corresponding to the zoom instruction, and the result is transmitted to the image reception device 30. Details of the cropping and image compression of the captured image in the image transmission device 20 are described below.

FIG. 2 shows a functional block diagram of an image transmission/reception system. An image transmission device 20 comprises a camera section 21 which captures images; an image processing section 22 that performs image processing of images captured by the camera section 21; and a transmission/reception section 23 that transmits and receives data and control signals (image data, zoom instructions, and the like) with the image reception device 30. On the other hand, the image reception device 30 includes a transmission/reception section 31 that transmits and receives data and control signals with image transmission devices 20; an image processing section 32 that performs image processing of captured images that have been received; an image display section 33 that displays captured images after image processing by the image processing section 32; and an input section 34 that inputs zoom instructions and the like in order to display zoomed images desired by a user or the like on the image display section 33.

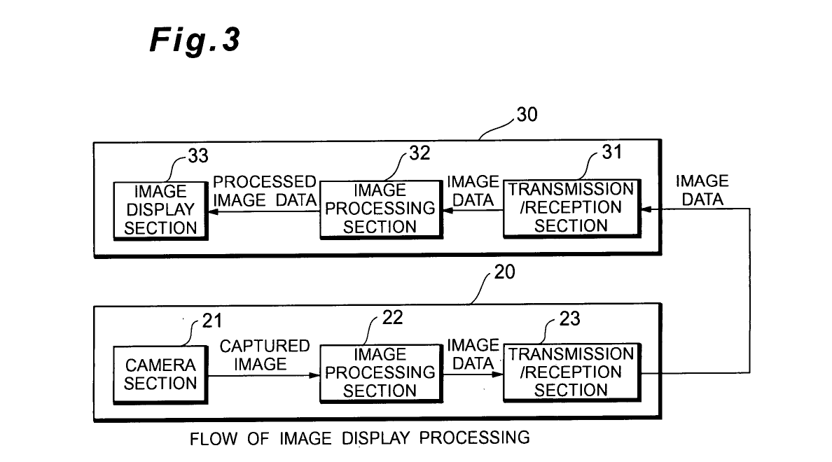

FIG. 3 shows the series of processing until a captured image is displayed. The image transmission device 20 uses the image processing section 22 to convert into digital image data an image captured by the camera section 21, and this data is modulated by the transmission/reception section 23 and transmitted to the image reception device 30 as a wireless signal. The image reception device 30 receives this wireless signal at the transmission/reception section 31, and demodulates the digital image data of the captured image. The demodulated digital image data is subjected to image processing so as to conform to the display size of the image processing section 32, and is then displayed on the image display section 33.

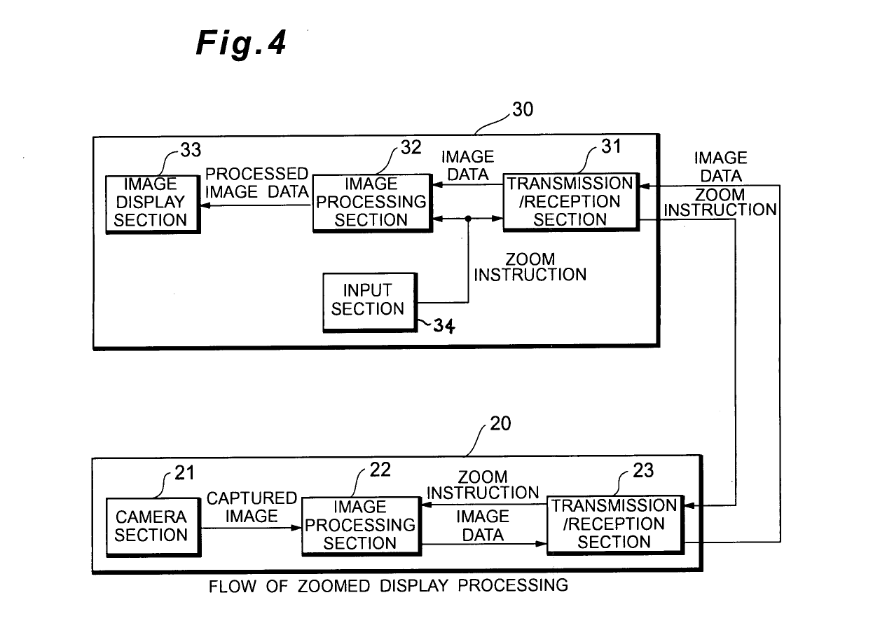

FIG. 4 shows the series of processing until a zoomed image, subjected to digital zoom processing, is displayed. In order to zoom and display an image displayed on the image display section 33, the user operates the input section 34 to input a zoom instruction that specifies a zoom range (captured image corners, or position and size of a selected range, or similar). The zoom instruction is modulated in a radio wave in the transmission/reception section 31, and is transmitted to the image transmission device 20 as a control signal. When the transmission reception section 23 receives a zoom instruction from the image reception device 30, the image processing section 22 performs image cropping and image compression of the image captured by the camera section 21 according to the zoom instruction. The compressed digital image data is modulated in the transmission/reception section 23 and transmitted as a wireless signal to the image reception device 30. The image reception device 30 receives the wireless signal in the transmission/reception section 31, and demodulates the digital image data of the captured image. The demodulated digital image data is subjected to interpolation and other image processing so as to conform to the display size of the image processing section 32, and is then displayed on the image display section 33.

However, when the above-described method is used to display a zoomed image, a time delay occurs from the time of input of the zoom instruction to the input section 34 by the user until the image is displayed on the image display section 33. This time delay depends on the time for wireless transmission of the image, captured by the camera section 21, to the image reception device 30. In order to minimize this time delay and quickly display the zoomed image, the zoom instruction input to the input section 34 is sent to the image processing section 32 substantially simultaneously with transmission by the transmission/reception section 31 to the image transmission device 20. The image processing section 32 performs the digital zoom processing specified by the zoom instruction on the digital image data displayed at that time, and displays the zoomed image on the image display section 33. The digital zoom processing in the image processing section 32 should be performed, at least, during the period in which the zoomed image (the image cropped according to the zoom instruction) is transmitted from the image transmission device 20 to the image reception device 30.

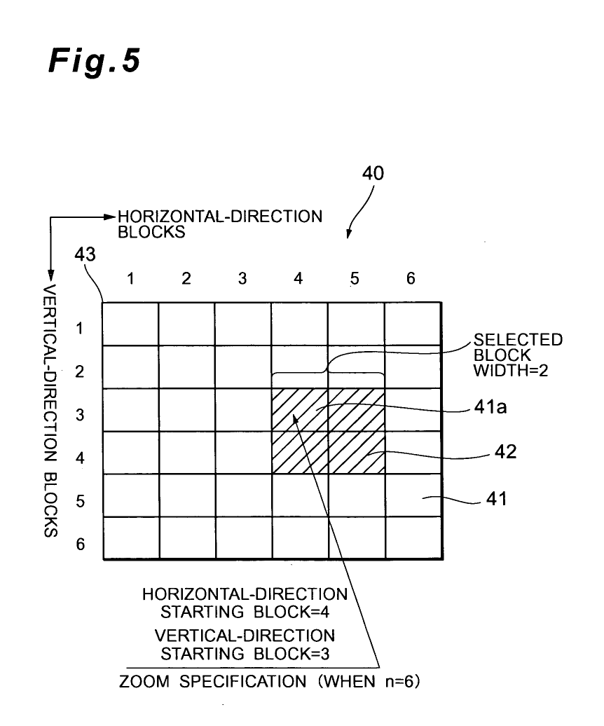

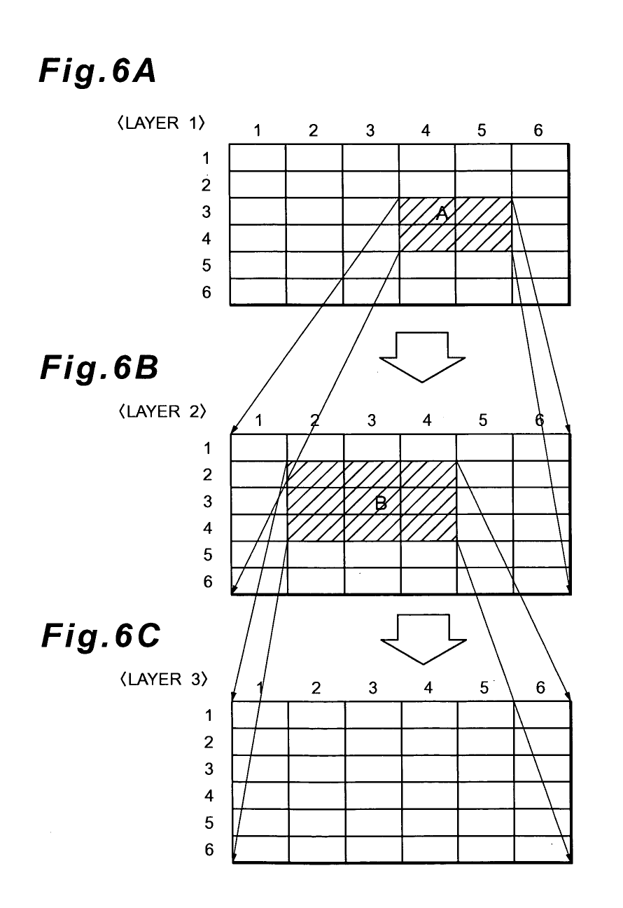

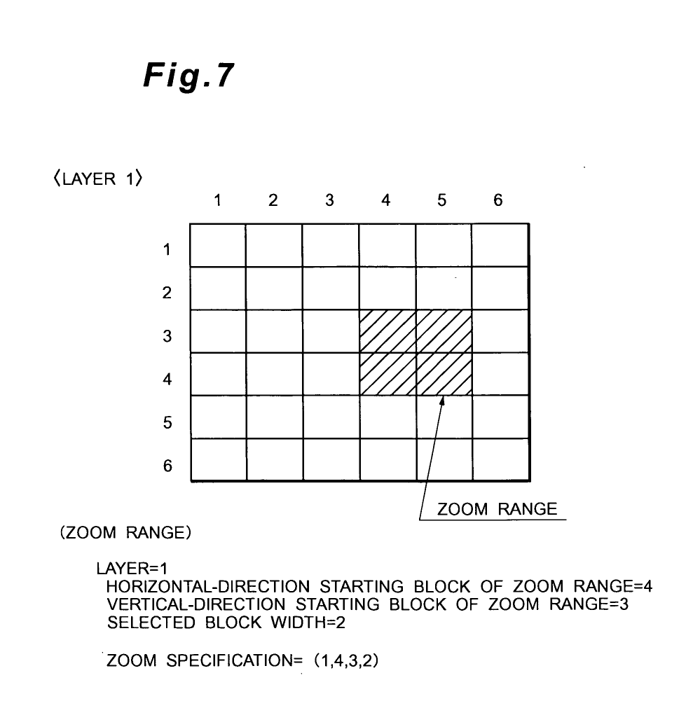

Next, the method of specification of zoom instructions is described. As shown in FIG. 5, a captured image 40 is divided into a plurality of small images 41 arranged in the horizontal and vertical directions. Here an example of division into an n×n matrix (n=6) is shown. In the figure, the plurality of small images 41 denoted by shading represent the selected range 42 to be zoomed. A zoom instruction is specified in terms of the layer, horizontal-direction starting block, vertical-direction starting block, and selection block width of the selected range 42. Layers are described below; here, the horizontal-direction starting block, vertical-direction starting block, and selected block width are explained. When a corner of the captured image 40 is taken as a reference point 43, the horizontal-direction starting block and vertical-direction starting block specify the coordinates, relative to the reference point 43, of the small image 41a in closest proximity to the reference point 43 among the plurality of small images 41 belonging to the selected range 42. These relative coordinates are specified by the number of small images in the horizontal direction and vertical direction. Here, the horizontal-direction starting block is 4, and the vertical-direction starting block is 3. The selected block width is the larger number of small images among the small images in the horizontal direction of the selected range 42 (number of blocks in horizontal direction) and the number of small images in the vertical direction (number of blocks in vertical direction). In the example shown in the figure, the number of small images is 2 in both the horizontal and the vertical directions, so that the selected block width is 2. The layer represents the number of times zooming is performed; an original image which has not been zoomed is taken to be a “layer 1” image (FIG. 6A). An image resulting from zooming of the area of a selected range A in “layer 1” is then a “layer 2” image (FIG. 6B). An image resulting from zooming of the area of a selected range B in “layer 2” is a “layer 3” image (FIG. 6C). Hereafter, an image resulting from m zoom operations is called a “layer m+1” image. By thus specifying the relative address of a selected range, the dependence on the image size can be reduced in data exchanges between the image transmission device 20 and image reception device 30. To summarize the above explanation, a zoom instruction which for example specifies zooming of the selected range shown in FIG. 7 can be denoted by (1,4,3,2). Here “1” is the layer, “4” is the horizontal-direction starting block, “3” is the vertical-direction starting block, and “2” is the selected block width. The zoom instruction may for example be issued by key input (number input) to the input section 34.

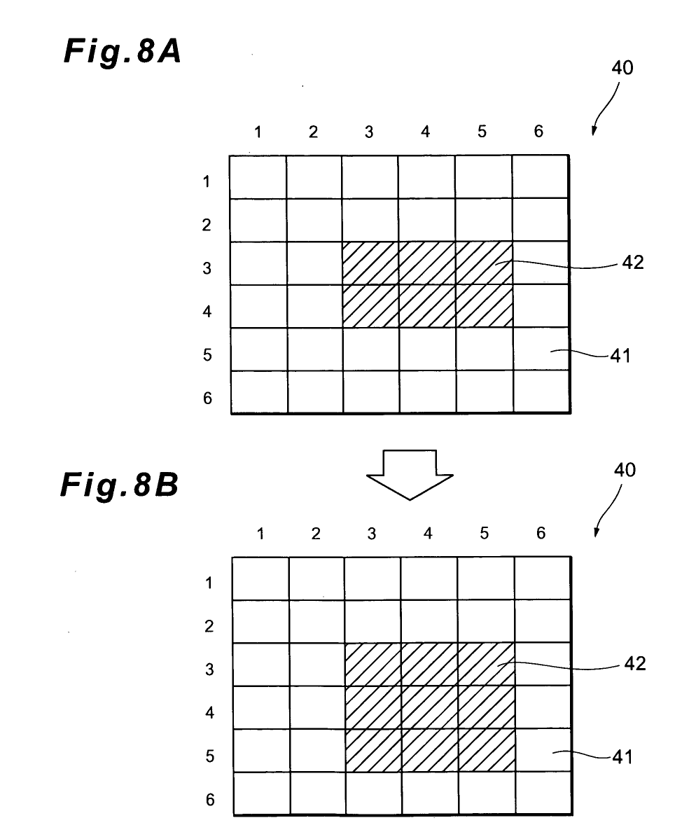

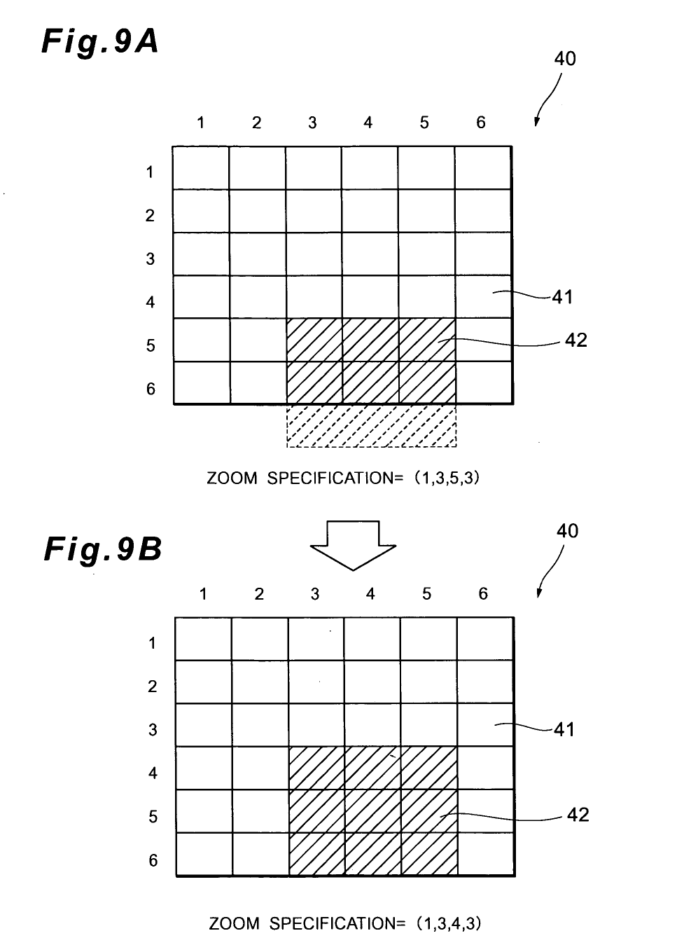

As shown in FIG. 8A, when the number of horizontal-direction blocks and the number of vertical-direction blocks in the selected range 42 differ, it is desirable that correction be performed such that the number of horizontal-direction blocks and the number of vertical-direction blocks in the selected range 42 are the same, as in FIG. 8B. In this case, it is desirable that the smaller among the number of horizontal-direction blocks and the number of vertical-direction blocks be increased so as to be equal to the larger. Further, when as in FIG. 9A the selected range 42 extends outside the range of the captured image 40, it is desirable that the zoom instruction be corrected such that the selected range 42 is contained within the captured image 40, as in FIG. 9B. Here the zoom instruction in FIG. 9A is (1,3,5,3), and the zoom instruction in FIG. 9B is (1,3,4,3).

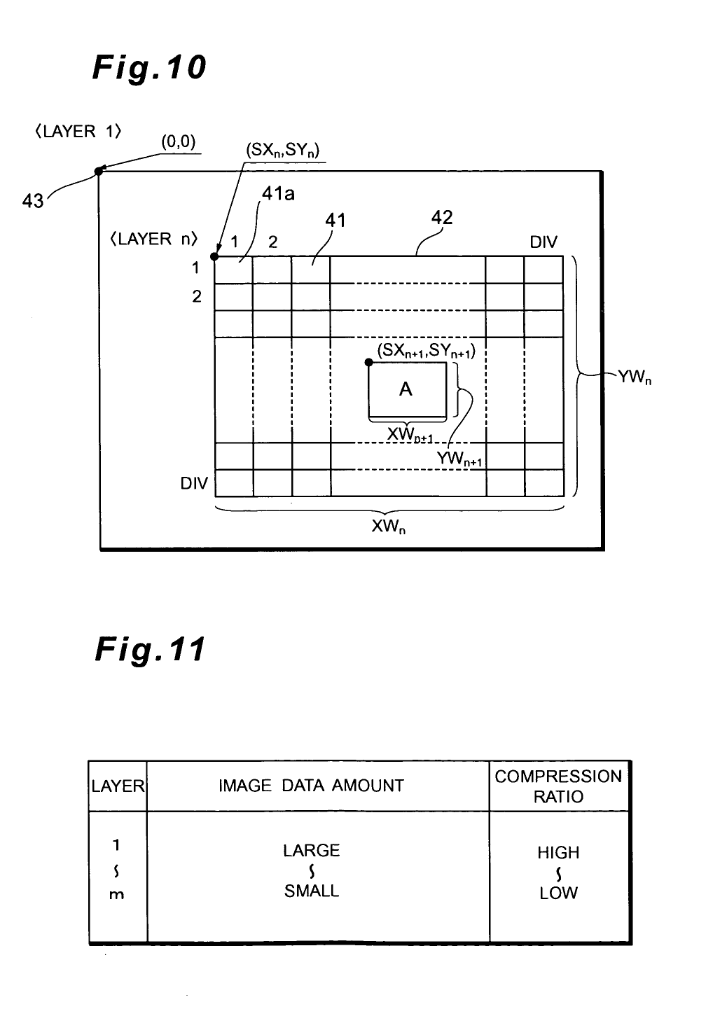

When a selected range is specified by a zoom instruction, the image processing section 22 of the image transmission device 20 performs cropping of the image according to the zoom instruction. The image processing section 22 performs the following calculations in order to crop the image according to the zoom instruction received from the image reception device 30. First, assume that the layer specified by the zoom instruction is n, the horizontal-direction starting block is SBX, the vertical-direction starting block is SBY, the selected block width is BW, and the number of matrix divisions is DIV. Then, taking the absolute coordinates (hereafter called the absolute starting coordinates) of the small image 41a in closest proximity to the reference point 43 among the small images 41 comprised by the selected range 42 in the layer n, as shown in FIG. 10, to be (SXₙ, SYₙ), the horizontal-direction display width to be XWₙ, and the vertical-direction display width to be YWₙ, then the absolute starting coordinates (SXₙ₊₁, SYₙ₊₁) of the area A to be cropped by the zoom operation, and the horizontal-direction display width XWₙ₊₁ and vertical-direction display width YWₙ₊₁ can be calculated as follows.
SXₙ₊₁=SXₙ+XWₙ/DIV×SBX i.
SYₙ₊₁=SYₙ+YWₙ/DIV×SBY ii
XWₙ₊₁=XWₙ/DIV×BW iii
YWₙ₊₁=YWₙ/DIV×BW iv

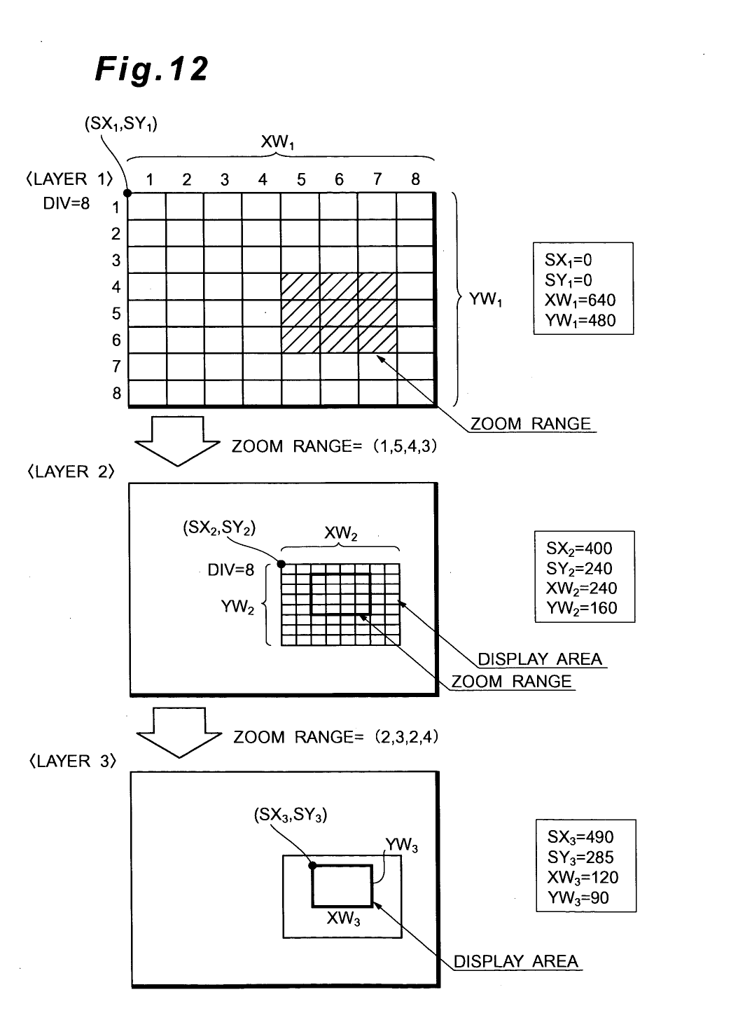

The initial values are set to n=1, SX₁=0, SY₁=0, XW₁, YW₁. FIG. 12 is an example showing the absolute starting coordinates and display widths in each of the layers resulting from image cropping, starting from layer 1.

After performing image cropping according to the above-described calculations, the image processing section 22 of the image transmission device 20 performs image compression. When the image processing section 32 of the image reception device 30 receives a compressed image, resolution conversion is performed, and image processing executed so as to conform to the dimensions of the image display section 33. However, an image of large dimensions has a large amount of data, and an image of small dimensions has a small amount of image data. Further, when digital zooming is performed, because image cropping and enlargement are used, the quality of the displayed image is degraded. Hence the compression ratio is changed such that the amount of image data after compression is substantially uniform, regardless of the size of the zoomed image, so that the image transmission time is substantially constant. This relation is illustrated in FIG. 11. As shown in such figure, the fewer the number of layers, the larger is the amount of image data, so that the image compression ratio is higher.

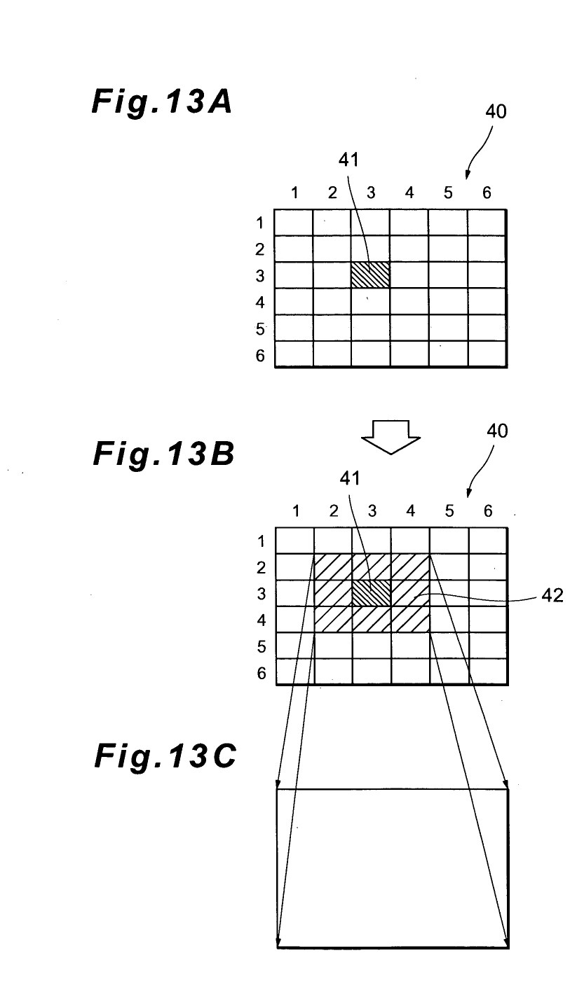

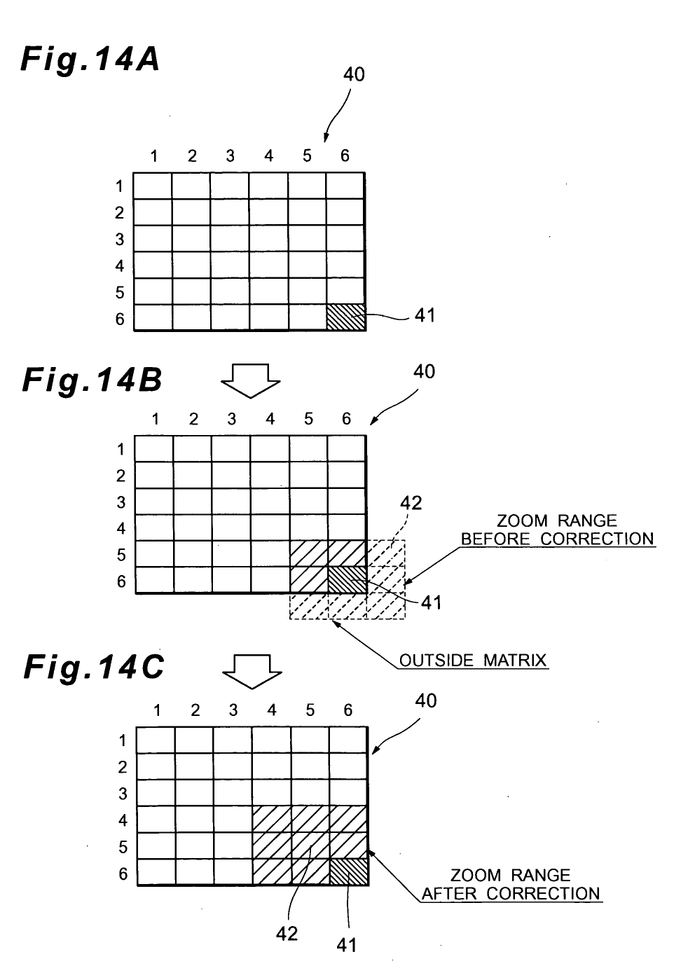

A configuration may be adopted in which, when specifying the selected range 42 for zooming, rather than inputting numbers for (layer, horizontal-direction starting block, vertical-direction starting block, selected block width), the selected range 42 is instead automatically confirmed by selecting one particular small image 41. For example, when as shown in FIG. 13A a cursor or the like is manipulated on a captured image 40 which has been divided into a 6×6 matrix and a small image 41 is selected, a 3×3 matrix centered on the small image 41 is selected as the selected range 42, as shown in FIG. 13B, and digital zoom processing is performed as shown in FIG. 13C. In this case, if a small image 41 near a corner of the captured image 40 is selected as shown in FIG. 14A, then the selected range 42 extends outside the range of the captured image 40, as in FIG. 14B; hence it is desirable that the selected range 42 be corrected such that the selected range 42 is contained within the range of the captured image 40, as in FIG. 14C. If such one-touch specification of the selected range 42 is made possible, a zoom instruction can be issued quickly, for excellent convenience of use.

In this aspect, by changing the image compression ratio such that the time for image transmission is substantially constant, zoomed images can be quickly displayed on an image reception device, even in a system employing low-bitrate wireless transmission equipment.

While the invention has been described herein with reference to illustrative features and embodiments, other variations, modifications and alternative embodiments of the invention will readily suggest themselves to those of ordinary skill in the art based on the disclosure herein, and therefore are to be regarded as being within the spirit and scope of the invention.

1. An image transmission device, comprising a camera section which captures images, a transmission/reception section which transmits, to an image reception device, captured images which have been captured by said camera section, and an image processing section which performs image processing, changing the image compression ratio such that the time for transmission of images to said image reception device is substantially constant.

2. The image transmission device according to claim 1, wherein said image processing section performs image compression of a selected range, in said captured image, which has been specified as a zoom range.

3. The image transmission device according to claim 2, wherein, when a corner of a captured image which has been equally divided into a plurality of small images arranged in the horizontal direction and vertical direction is established as a reference point, said selected range is specified by a position relative to said reference point and by the numbers of small images in the horizontal and vertical directions, which represent the size of said selected range.

4. The image transmission device according to claim 1, wherein said transmission/reception section performs image transmission by wireless transmission to said image reception device.

5. The image reception device described in claim 2, comprising a transmission/reception section which receives captured images transmitted from said image transmission device, an image processing section which performs image processing of a captured image received by said transmission/reception section, an image display section which displays a captured image which has been subjected to image processing by said image processing section, and an input section to input zoom instructions specifying a selected range of said captured image; wherein
when a zoom instruction is input to said input section,
said transmission/reception section transmits said zoom instruction to said image transmission device, and in addition said image processing section performs the zoom processing specified by said zoom instruction on the captured image being displayed on said image display section.

6. The image reception device described in claim 2, comprising a transmission/reception section which receives captured images transmitted from said image transmission device, an image processing section which performs image processing of a captured image received by said transmission/reception section, an image display section which displays a captured image which has been subjected to image processing by said image processing section, and an input section to input zoom instructions specifying a selected range of said captured image; wherein
when a zoom instruction is input to said input section,
said transmission/reception section transmits said zoom instruction to said image transmission device, and in addition said image processing section performs the zoom processing specified by said zoom instruction on the captured image being displayed on said image display section.

7. The image reception device described in claim 3, comprising a transmission/reception section which receives captured images transmitted from said image transmission device, an image processing section which performs image processing of a captured image received by said transmission/reception section, an image display section which displays a captured image which has been subjected to image processing by said image processing section, and an input section to input zoom instructions specifying a selected range of said captured image; wherein
when a zoom instruction is input to said input section,
said transmission/reception section transmits said zoom instruction to said image transmission device, and in addition said image processing section performs the zoom processing specified by said zoom instruction on the captured image being displayed on said image display section.

8. The image reception device described in claim 4, comprising a transmission/reception section which receives captured images transmitted from said image transmission device, an image processing section which performs image processing of a captured image received by said transmission/reception section, an image display section which displays a captured image which has been subjected to image processing by said image processing section, and an input section to input zoom instructions specifying a selected range of said captured image; wherein
when a zoom instruction is input to said input section,
said transmission/reception section transmits said zoom instruction to said image transmission device, and in addition said image processing section performs the zoom processing specified by said zoom instruction on the captured image being displayed on said image display section.

9. An image transmission/reception system, comprising
(A) an image transmission device, comprising (i) a camera section which captures images, (ii) a transmission/reception section which transmits, to an image reception device, captured images which have been captured by said camera section, and (iii) an image processing section which performs image processing, changing the image compression ratio such that the time for transmission of images to said image reception device is substantially constant; and
(B) an image reception device, comprising (i) a transmission/reception section which receives captured images transmitted from said image transmission device, (ii) an image processing section which performs image processing of a captured image received by said transmission/reception section, (iii) an image display section which displays a captured image which has been subjected to image processing by said image processing section, and (iv) an input section to input zoom instructions specifying a selected range of said captured image;
wherein when a zoom instruction is input to said input section, said transmission/reception section (B)(i) transmits said zoom instruction to said image transmission device, and in addition said image processing section (B)(ii) performs the zoom processing specified by said zoom instruction on the captured image being displayed on said image display section; and
wherein said image transmission device is a cordless telephone handset, and said image reception device is a cordless telephone base unit.

10. The image transmission/reception system according to claim 9, wherein said image processing section (A)(iii) performs image compression of a selected range, in said captured image, which has been specified as a zoom range.

11. The image transmission/reception system according to claim 10, wherein, when a corner of a captured image which has been equally divided into a plurality of small images arranged in the horizontal direction and vertical direction is established as a reference point, said selected range is specified by a position relative to said reference point and by the numbers of small images in the horizontal and vertical directions, which represent the size of said selected range.

12. The image transmission/reception system according to claim 9, wherein said transmission/reception section (A)(ii) performs image transmission by wireless transmission to said image reception device.
